(19) United States
(12) Patent Application Publication
(10) Pub. No.: US 2019/0067965 A1
(43) Pub. Date: Feb. 28, 2019

(54) Separable Mobile Power Source Bracket

(71) Applicants: Yao-Te Liang, Dongshi Township (TW); Jui-Shu Lin, Dongshi Township (TW); Shu-Er Liang, New Taipei City (TW); Sheng-Chi Liang, Dongshi Township (TW)

(72) Inventor: Sheng-Chi Liang, Dongshi Township (TW)

(21) Appl. No.: 15/706,886

(22) Filed: Sep. 18, 2017

(30) Foreign Application Priority Data
Aug. 25, 2017 (TW) 106212577

(51) Int. Cl. H02J 7/00; H01M 2/10; H01M 10/46; H01M 10/42; H04B 1/3888

(52) U.S. Cl. CPC H02J 7/0042; H01M 2/1022; H01M 10/46; H01M 2220/30; H02J 7/0052; H04B 1/3888; H01M 10/425

(57) ABSTRACT

A separable mobile power source bracket is provided. The mobile power source is composed of a large edge external case, a small edge external case, a charging battery and a circuit module. Both the large edge external case and the small edge external case can be assembled into a completely external case through magnetic suction. The charging battery is accommodated inside the back surface case of the large edge external case. The external case can be provided for accommodating a mobile phone for protection. When the small edge external case is held and detached by imposing force, the small edge external case is peeled off the top surface of the large edge external case to lean the bottom surface of the small edge external case against the back surface of the large edge external case so that the mobile phone is at a tilt angle.

### BACKGROUND OF THE INVENTION

### Field of the Invention

The present invention relates to a separable mobile power source bracket, and more particularly to a separable mobile power source bracket that assembles a small edge external case and a large edge external case into a completely external case through magnetic suction to provide accommodating a mobile phone so as to achieve protection, and moreover, the small edge external case can be peeled off the top surface of the large edge external case, and the bottom surface of the small edge external case is attached to the back surface of the large edge external case to allow the mobile phone to show oblique application.

### Description of the Related Art

A conventional mobile power source has an external case capable of accommodating a mobile phone to be protected by the external case. The inside of the rear case body of the external case comprises a chargeable battery (lithium battery for example) while the bottom portion is disposed with a charging hole and a charging plunger. The charging hole and the charging plunger are electrically connected to the charging battery. When the mobile phone is accommodated in the external case, the charging hole attached to the mobile phone would be plugged by the charging plunger of the external case. The mobile phone can use the power of the charging battery. When one end of the charging wire is plugged into the charging hole of the external case and another end is plugged into supply mains or another power source, power can supply in the charging battery (lithium battery for example).

The conventional mobile power source can protect the mobile phone and supply power to the mobile phone and can be further charged to have extremely convenience during use. Therefore, it is so popular. Seriously, the conventional power source exactly has practicality without such shortcoming. However, this conventional mobile power source is not good enough during high technology era and must be further developed to provide more added functions in order to increase its practicality.

### SUMMARY OF THE INVENTION

In view of the aforementioned drawbacks of the prior art, the inventor of the present invention conducted researches and experiments, and finally developed a mobile power source capable of increasing added functions to improve practicality.

Therefore, it is a primary objective of the present invention to provide a separable mobile power source bracket capable of assembling a small edge external case and a large edge external case into a completely external case by way of magnetic suction so as to accommodate a mobile phone as protection.

It is a secondary objective of the present invention to provide a separable mobile power source bracket capable of peeling the small edge external case off the top surface of the large edge external case and then leaning the bottom surface of the small edge external case against the back surface of the large edge external case so that the mobile phone can be used at a slope.

To achieve above mentioned objective, the present invention is provided with a separable mobile power source bracket composed of a large edge external case, a small edge external case, a charging battery and a circuit module, wherein a top surface of the large edge external case is opened, and a small engaging bar is respectively disposed at two sides of the top surface, and an inside of the top surface comprises a set of magnetic suction pieces, and a bottom surface of the large edge external case has a charging hole and a charging plunger; and a bottom surface of the small edge external case is opened, and a small notch is respectively disposed at two sides of the bottom surface, an inside of the bottom surface comprises a set of magnetic suction members; and the charging battery and the circuit module are accommodated inside a back surface of the large edge external case, and the charging battery and the circuit module are electrically connected to the charging hole and the charging plunger, and, in the back surface case of the large edge external case, a large magnetic suction sheet is comprised at the external side of the charging battery; and when the bottom surface of the small edge external case is approached to the top surface of the large edge external case, the magnetic suction member of the small edge external case is rapidly approached to the magnetic suction piece of the large edge external case due to magnetic suction effect, and the small engaging bar at the top surface of the large edge external case is correspondingly inserted into the small notch of the bottom surface of the small edge external case to position and assemble a completely external case; and the small edge external case is held and detached by imposing force so that the small edge external case is peeled off the top surface of the large edge external case to lean the bottom surface of the small edge external case against the back surface of the large edge external case.

According to the above mentioned separable mobile power source bracket, the magnetic suction piece and the large magnetic suction sheet of the large edge external case are metal sheets.

According to the above mentioned separable mobile power source bracket, the magnetic suction member of the small edge external case is a magnet.

According to the above mentioned separable mobile power source bracket, a height of the large edge external case occupies five sixths of the completely external case while a height of the small edge external case occupies one sixths of the completely external case.

According to the above mentioned separable mobile power source bracket, the bottom surface of the small edge external case is disposed with a plurality of micro-gaskets.

### BRIEF DESCRIPTION OF THE DRAWINGS

FIG. 1 is a perspective view of an embodiment of the present invention;

FIG. 2 is an exploded view of an embodiment of the present invention;

FIG. 3 is a front view of an embodiment of the present invention;

FIG. 4 is a perspective view of accommodating a mobile phone of an embodiment of the present invention;

FIG. 5 is a perspective view for changed bracket in use according to an embodiment of the present invention;

FIG. 6 is a side view for changed bracket in use according to an embodiment of the present invention;

FIG. 7 is a side view for changed bracket in use and a small edge external case in position of upper moving in accordance with an embodiment of the present invention;

### DETAILED DESCRIPTION OF THE PREFERRED EMBODIMENTS

The technical characteristics, contents, advantages and effects of the present invention will be apparent with the detailed description of a preferred embodiment accompanied with related drawings as follows.

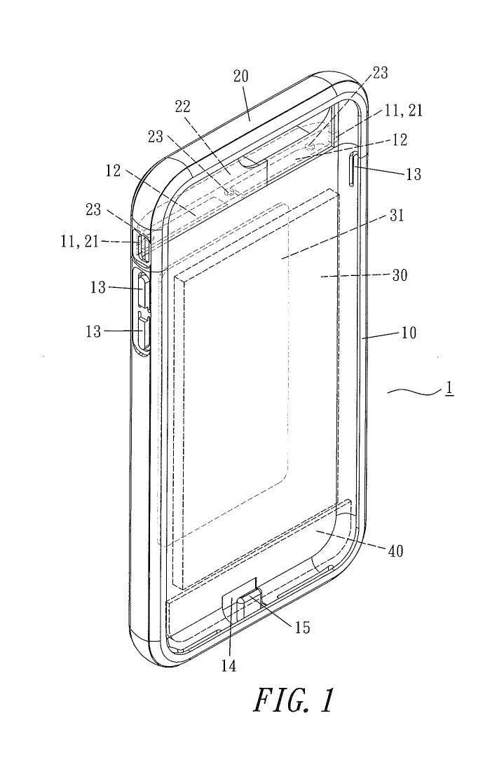

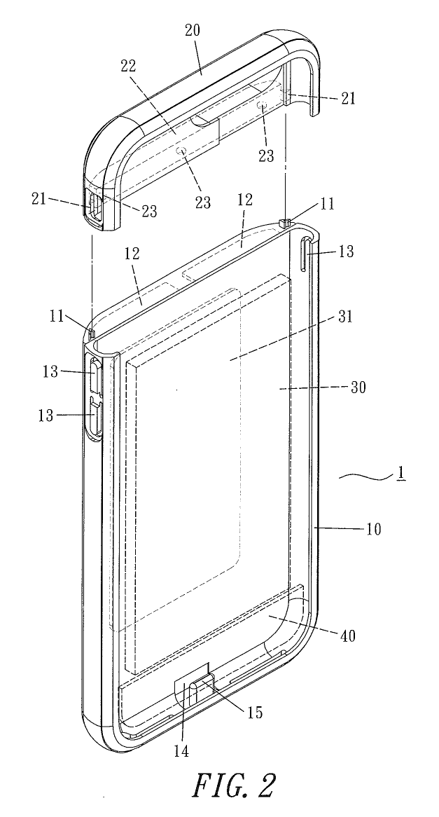

With reference to FIGS. 1-3 for a mobile power source 1 according to an embodiment, the structure is composed of a large edge external case 10, a small edge external case 20, a charging battery 30 and a circuit module 40. The large edge external case 10 and the small edge external case 20 can be magnetically sucked to compose a completely external case, wherein the height of the large edge external case 10 occupies five sixths of the completely external case. A top surface of the large edge external case 10 is opened. A small engaging bar 11 is respectively disposed at two sides of the top surface while the inside of the top surface comprises a set of magnetic suction pieces 12 (metal sheet body for example). Keypads 13 are respectively disposed on two sides. The bottom surface has a charging hole 14 and a charging plunger 15. However, the keypads 13, the charging hole 14 and the charging plunger 15 are the same as conventional devices, and there is no need to further describe herein.

The height of the small edge external case 20 occupies one sixths of the completely external case. A bottom surface of the small edge external case 20 is opened. A small notch 21 is respectively disposed at two sides of the bottom surface. The inside of the bottom surface comprises a set of magnetic suction members 22 (magnet for example) while several micro-gaskets 23 are disposed at the bottom surface. When the bottom surface of the small edge external case 20 is approached to the top surface of the large edge external case 10, the magnetic suction member 22 (magnet for example) is rapidly approached to the magnetic suction piece 12 (metal sheet body for example) due to magnetic suction effect, and the small engaging bar 11 at the top surface of the large edge external case 10 would be correspondingly inserted into the small notch 21 at the bottom surface of the small edge external case 20 to achieve positioning, thereby assembling a completely external case. During the process, the micro-gasket 23 exactly buffers impact fore of magnetic suction between the small edge external case 20 and the large edge external case 10.

The charging battery 30 (lithium battery for example) and the circuit module 40 can be comprised inside the back surface case of the large edge external case 10, and the charging battery 30 and the circuit module 40 are electrically connected to the charging hole 14 and the charging plunger 15. However, the foregoing features are the same as the conventional structure, and there is no need to illustrate herein. The difference is that, in the back surface case of the large edge external case 10, a large magnetic suction sheet 31 (metal sheet body for example) is comprised at the external side of the charging battery 30.

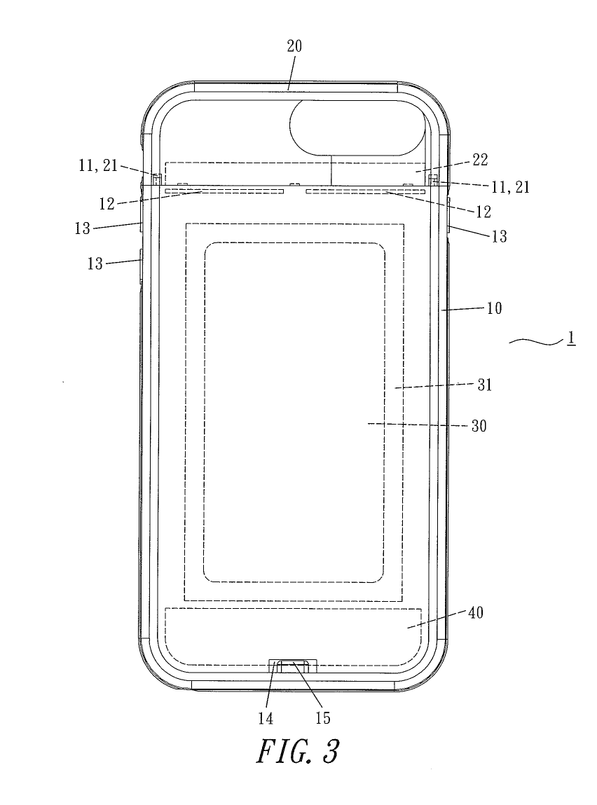

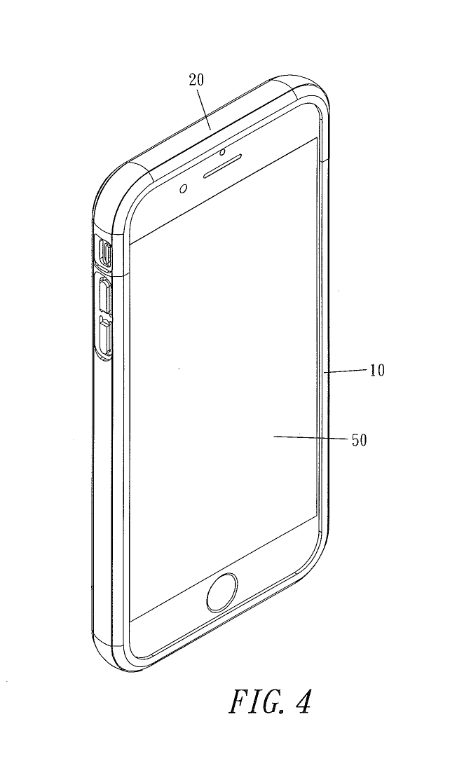

According to the foregoing structure composition, the bottom surface of the small edge external case 20 is mutually sucked with the top surface of the large edge external case 10 to assemble a completely external case so as to finish a mobile power source 1 as shown in FIGS. 1, 3. During the use status, as shown in FIG. 4, a mobile phone 50 is accommodated in the external case so that the circumference and back surface of the mobile phone 50 are protected by the external case composed of the small edge external case 20 and the large edge external case 10, and the charging hole attached to the mobile phone 50 is plugged with the charging plunger 15 of the large edge external case 10. The mobile phone 50 can use power of the charging battery 30. When one end of additional reserved charging wire is plugged into the charging hole 14 of the large edge external case 10 and another end is plugged into supply mains or another power source, power can be charged into the charging battery 30. However, the use state shown in FIG. 4 is the same as the conventional example, and there is no need to illustrate herein.

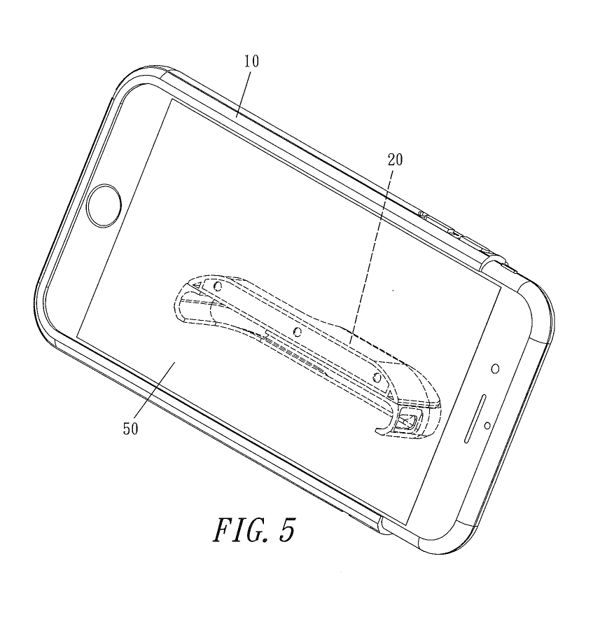

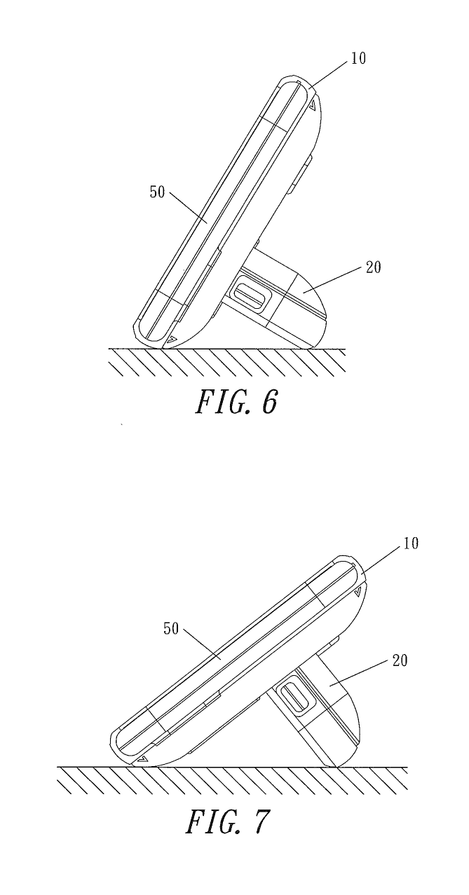

The efficacy of the invention is that during the state shown in FIG. 4, the small edge external case 20 can be separated from the top surface of the large edge external case 10 any time. The small edge external case 20 is held and can be peeled off the top surface of the large edge external case 10 by imposing motion of detachment. Afterward the magnetic suction member 22 at the bottom surface of the small edge external case 20 leans against the back surface of the large edge external case 10 so that the magnetic suction member 22 (magnet for example) of the small edge external case 20 would be rapidly close to the large magnetic suction sheet 31 (metal sheet body for example) inside the back surface of the large edge external case 10 due to magnetic suction effect. Finally, the bottom surface of the small edge external case 20 would be sucked to the back surface of the large edge external case 10 to form the use state shown in FIGS. 5, 6.

In use state shown in FIGS. 5, 6, although the mobile phone 50 is accommodated in the large edge external case 10 for protection, the mobile phone 50 is in a horizontal mode so that the mobile phone 50 can be at a slope through support of the small edge external case 20 to facilitate a user to watch in hands-free condition.

The position of sucking the small edge external case 20 on the back surface of the large edge external case 20 is not limited and can be at the range of the large magnetic suction sheet 31. Therefore, if the small edge external case 20 is upwardly moved to form a use state shown in FIG. 7, obviously, the tilt angle of the mobile phone 50 is larger when the small edge external case 20 is in a lower position so that the mobile phone can be properly watched at long distance. When the position of the small edge external case 20 is upwardly moved (at higher position), the tilt angle of the mobile phone 50 becomes smaller and can be properly watched at close range.

Upon the foregoing, it should be noted that a mobile power source is composed of a large edge external case, a small edge external case, a charging battery and a circuit module. Both the large edge external case and the small edge external case can be magnetically sucked to assemble a completely external case. The charging battery is accommodated inside of the back case of the large edge external case. The external case can accommodate a mobile phone for protection. The small edge external case is detached by imposing force so that the small edge external case can be peeled off the top surface of the large edge external case to lean the bottom surface of the small edge external case against the back surface of the large edge external case so as to have oblique application for the mobile phone.

Accordingly, the separable mobile power source bracket of the present invention has absolute novelty since it was not shown in conventional products ever. Moreover, while the invention has been described by means of specific embodiments, numerous modifications and variations could be made thereto by those skilled in the art without departing from the scope and spirit of the invention set forth in the claims.

What is claimed is:

1. A separable mobile power source bracket composed of a large edge external case, a small edge external case, a charging battery and a circuit module, wherein a top surface of the large edge external case is opened, and a small engaging bar is respectively disposed at two sides of the top surface, and an inside of the top surface comprises a set of magnetic suction pieces, and a bottom surface of the large edge external case has a charging hole and a charging plunger; and a bottom surface of the small edge external case is opened, and a small notch is respectively disposed at two sides of the bottom surface, an inside of the bottom surface comprises a set of magnetic suction members; and the charging battery and the circuit module are accommodated inside a back surface of the large edge external case, and the charging battery and the circuit module are electrically connected to the charging hole and the charging plunger, and, in the back surface case of the large edge external case, a large magnetic suction sheet is comprised at the external side of the charging battery; and when the bottom surface of the small edge external case is approached to the top surface of the large edge external case, the magnetic suction member of the small edge external case is rapidly approached to the magnetic suction piece of the large edge external case due to magnetic suction effect, and the small engaging bar at the top surface of the large edge external case is correspondingly inserted into the small notch of the bottom surface of the small edge external case to position and assemble a completely external case; and the small edge external case is held and detached by imposing force so that the small edge external case is peeled off the top surface of the large edge external case to lean the bottom surface of the small edge external case against the back surface of the large edge external case.

2. The separable mobile power source bracket of claim 1, wherein the magnetic suction piece and the large magnetic suction sheet of the large edge external case are metal sheets.

3. The separable mobile power source bracket of claim 1, wherein the magnetic suction member of the small edge external case is a magnet.

4. The separable mobile power source bracket of claim 1, wherein a height of the large edge external case occupies five sixths of the completely external case while a height of the small edge external case occupies one sixths of the completely external case.

5. The separable mobile power source bracket of claim 1, wherein the bottom surface of the small edge external case is disposed with a plurality of micro-gaskets.
